(19) United States
(12) Patent Application Publication
(10) Pub. No.: US 2005/0063198 A1
(43) Pub. Date: Mar. 24, 2005

(54) Decorative panel containing graphic representations of the illuminated religious symbols and commemorative or holiday signs

(75) Inventors: Vadim Azbel, Staten Island, NY (US); Mikhail Leybovich, Jersey City, NJ (US)

Correspondence Address: VADIM AZBEL, 459 ST. ANDREWS RD., STATEN ISLAND, NY, 10306, US

(73) Assignee: Vadim Azbel, Staten Island, NY (US)

(21) Appl. No.: 10/605,296

(22) Filed: Sep. 20, 2003

(51) Int. Cl. F21S 4/00

(52) U.S. Cl. 362/565

(57) ABSTRACT

A new display comprised of a panel containing graphic representations of the illuminated religious symbols and commemorative or holiday signs. The panel may be affixed to any curvatures including windows, car windshields or any other surface, serving as the outer boundary of the objects. The visual representation of the aforementioned symbols is illuminated by light-emitting chemical processes or physical devices. The panel can have any size and thickness that would fit individual applications. Specific embodiments are provided for plurality of the decorative purposes.

### BACKGROUND OF INVENTION

The invention relates to commemorative religious, illuminated holiday displays, used for decoration, holiday celebration, religious observance or similar purposes whenever public display of such information is needed.

### SUMMARY OF INVENTION

It is an objective of the present invention to develop an illuminated panel of the aforementioned kind that is portable, compact and easily attachable to surfaces such as car windshields, windows, glass doors or other surfaces of any geometric form from inside as well as outside. With the present invention, this is achieved by using luminescent film shaped in the form of the symbols, and embedded in the transparent flexible panel. The panel is supplied with an adhesive layer, suction cups or any other means of mounting it to the applicable surface.

anel elements that require additional contrast with the embedded symbols are provided with light-emitting electric devices with corresponding energy sources and control circuitry integrated into the panel display.

### BRIEF DESCRIPTION OF DRAWINGS

FIG. 1 General view of the illuminated panel

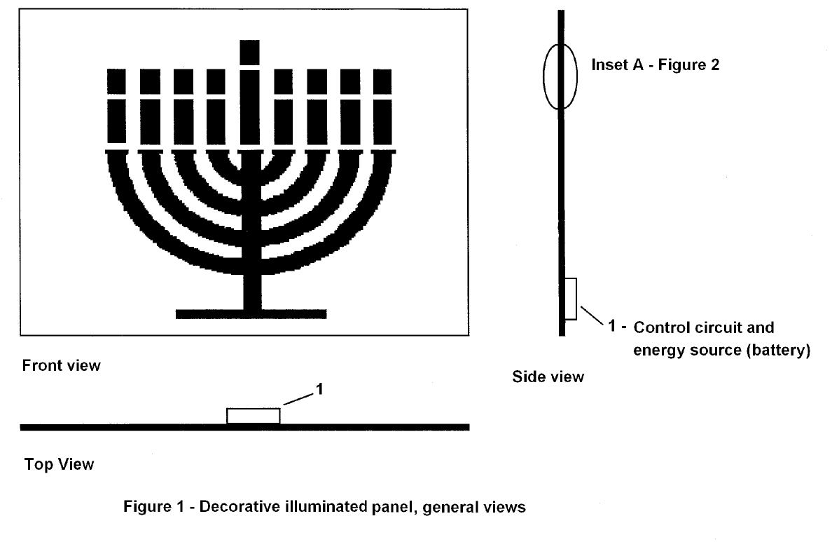

FIG. 2 Panel's cross-section (Inset A from FIG. 1)

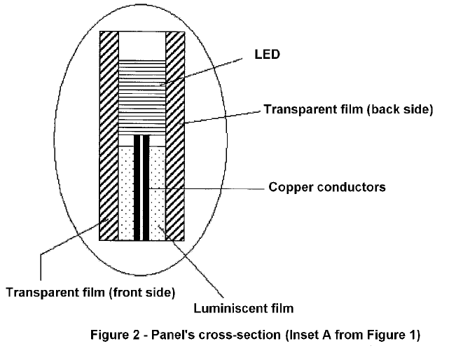

FIG. 3 Assembly Scheme

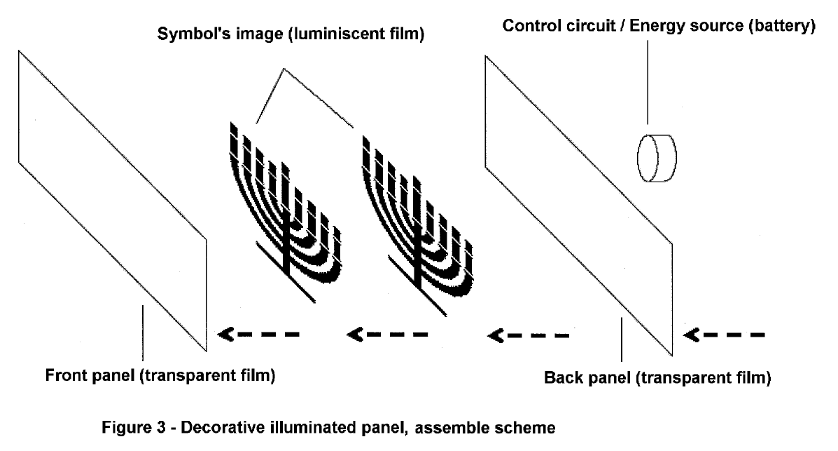

### DETAILED DESCRIPTION

The illuminated display includes smooth front and back surfaces. The shape of the religious, commemorative or holiday symbol (such as Menorah, birthday cake, Christmas tree, National Flag, etc.) is cut from luminescent film and embedded between two transparent layers of plastic. The front or back surface of the display panel may be covered by a transparent adhesive to provide an easy way of attaching it to the surface of windows, car windshields, glass doors or similar objects. The illuminated display panel usually has, but is not limited to, a rectangular shape of any suitable size.

Two pieces of luminescent film are cut in the form of the desired symbol and glued together, luminescent sides outward. Obtained item is glued to the sheet of transparent plastic, serving as a backside (background layer) for the display. Another sheet of the transparent plastic is applied to the other side of the described item and serves as a front side for the illuminated display. The resulting panel can be etched in any desirable form.

Whenever light-emitting devices are necessary to provide additional brightness to the parts of an image on the illuminated display panel, these light-emitting devices (such as Light Emitting Diodes or LEDs) are attached to the corresponding positions within the illuminated image. Copper conductors, connected to the LEDs, are placed between two layers of the luminescent film and extend outward through the slit in the background layer to be attached to the integrated control circuit/energy source (battery) element of the panel. This integrated control circuit/battery element is molded in the epoxy material and attached to the back side of the illuminated display panel.

While specific embodiments of the invention have been shown and described in detail to illustrate the inventive principles, it is understood that the invention may take a different form without departing from such principles.

1. Illuminated decorative panel, comprising of religious, commemorative or holiday symbols formed by light-emitting elements and control system with applicable energy source if necessary.

2. Illuminated decorative panel as recited in claim 1, wherein face is attachable to the surface of any geometry, depending on its application.

3. Illuminated decorative panel as recited in claim 1, wherein light-emitting elements are embedded in the panel

4. Illuminated decorative panel as recited in claim 3, wherein light-emitting elements are represented in a form of luminescent film.

5. Illuminated decorative panel as recited in claim 3, wherein light-emitting elements, that must be distinguished from the rest of the image, are placed on the panel for particular embodiments of the panel, are represented in a form of electric light-emitting devices.

6. Illuminated decorative panel as recited in claim 2, wherein the face of the panel is attachable to the surface of any form by means of an adhesive compound, static adhesion, vacuum suction cups or any other mean suited for particular embodiment.

7. Illuminated decorative panel as recited in claim 5, wherein electric light-emitting devices are used, containing an applicable energy source attached to the panel.

8. Illuminated decorative panel as recited in claim 7, wherein an electric control circuit is used to manipulate electric light-emitting devices.

9. Illuminated decorative panel as recited in claim 8, wherein an electric control circuit is attached to the panel

10. Illuminated decorative panel as recited in claim 4, wherein luminescent film formed in the shape of the religious, commemorative or holiday symbols is embedded in the panel.
